(19) United States
(12) Patent Application Publication
(10) Pub. No.: US 2020/0331454 A1
(43) Pub. Date: Oct. 22, 2020

(54) ACTIVE VIBRATION REDUCTION CONTROL APPARATUS AND METHOD OF HYBRID VEHICLE

(71) Applicants: HYUNDAI MOTOR COMPANY, Seoul (KR); KIA MOTORS CORPORATION, Seoul (KR)

(72) Inventors: Jun Mo AN, Suwon-si (KR); Young Kwan KO, Seoul (KR); Byung Hoon YANG, Seongnam-si (KR); Hyung Souk KANG, Seoul (KR)

(21) Appl. No.: 16/668,498

(22) Filed: Oct. 30, 2019

(30) Foreign Application Priority Data
Apr. 22, 2019 (KR) 10-2019-0046760

(51) Int. Cl. B60W 20/17; G05D 19/02; G01M 15/06; F16F 15/24

(52) U.S. Cl. CPC B60W 20/17; G05D 19/02; B60W 2030/206; F16F 15/24; G01M 15/06

(57) ABSTRACT

An active vibration reduction control apparatus of a hybrid vehicle includes: a vibration extraction device configured to extract a first vibration signal from a motor connected to a drive shaft of the hybrid vehicle; a torque generator configured to generate a first torque for vibration reduction based on the first vibration signal; and a controller configured to apply the first torque to the motor.

### CROSS-REFERENCE TO RELATED APPLICATION

This application claims the benefit of priority to Korean Patent Application No. 10-2019-0046760, filed in the Korean Intellectual Property Office on Apr. 22, 2019, the entire contents of which are incorporated herein by reference.

### TECHNICAL FIELD

The present disclosure relates to a technology for actively reducing vibration generated by an explosion in an internal combustion engine, by extracting a vibration signal (a vibration component) transmitted through a powertrain during an explosion stroke in the internal combustion engine and applying an anti-phase torque of the extracted vibration signal to a motor mounted in the powertrain.

### BACKGROUND

A hybrid vehicle refers to a vehicle that is driven by an efficient combination of two or more distinct types of power sources, but in general, refers to a vehicle that is driven by an engine that generates torque by burning a fuel (a fossil fuel such as gasoline) and an electric motor that generates torque by using battery power.

The engine generates the torque by combustion pressure during a cylinder power stroke. The engine torque contains a vibration component proportional to the number of explosions in the cylinder per shaft revolution due to a violent fluctuation in the combustion pressure. The vibration component is transmitted to a vehicle body through an engine mount and a drive shaft to cause vibration and noise and degrade ride comfort.

To solve these problems, the following methods have been proposed as passive methods: a method (a first method) of changing an engine operating point to avoid a range of frequencies over which vibration occurs; a method (a second method) of damping vibration by using low rigidity of a torsional damper; and a method (a third method) of changing a resonance range by mounting a dynamic damper.

However, the first method has a problem of deviation from an optimal operating point, the second method has a problem of poor effect on vibration damping due to the limit of low rigidity, and the third method has problems of poor fuel economy due to a weight increase and a cost rise due to additional cost.

### SUMMARY

The present disclosure has been made to solve the above-mentioned problems occurring in the prior art while advantages achieved by the prior art are maintained intact.

An aspect of the present disclosure provides an active vibration reduction control apparatus and method of a hybrid vehicle that generates a torque for vibration reduction based on a rotation angle of a motor in the hybrid vehicle, applies the torque for vibration reduction to the motor to reduce vibration, and generates and applies a new torque for vibration reduction when a vibration level of the motor exceeds a reference value, thereby preventing the level of vibration generated in the hybrid vehicle from exceeding the reference value.

The technical problems to be solved by the present disclosure are not limited to the aforementioned problems, and any other technical problems not mentioned herein will be clearly understood from the following description by those skilled in the art to which the present disclosure pertains. It will be easily understood that the aspects and advantages of the present disclosure can be accomplished by the means set forth in the appended claims and combinations thereof.

According to an aspect of the present disclosure, an active vibration reduction control apparatus of a hybrid vehicle includes: a vibration extraction device that extracts a vibration signal from a motor connected to a drive shaft of the hybrid vehicle; a torque generator that generates a first torque for vibration reduction based on the vibration signal; and a controller that applies the first torque to the motor.

The controller may stop applying the first torque and may then apply, to the motor, a second torque for vibration reduction that is generated by the torque generator, when a vibration level extracted by the vibration extraction device exceeds a reference value in the state in which the controller applies the first torque to the motor. At this time, the torque generator may generate the second torque based on a vibration signal extracted by the vibration extraction device after the application of the first torque is stopped.

The vibration extraction device may include a position monitor that measures a rotation angle of the motor, a speed calculator that calculates a speed signal by performing a differentiation on the rotation angle measured by the position monitor, and a vibration extractor that extracts a vibration signal by filtering the speed signal calculated by the speed calculator. The vibration extractor may be implemented with a band-pass digital filter.

The torque generator may include a reference signal generator that calculates a double rotation angle by multiplying the rotation angle of the motor, which is measured by the position monitor, by 2 and generates a reference signal using the double rotation angle.

The torque generator may further include a tunable filter that filters the reference signal, which is generated by the reference signal generator, by using a filter coefficient updated by a filter coefficient updater, a phase-difference calculator that calculates a phase difference between the reference signal generated by the reference signal generator and the vibration signal extracted by the vibration extraction device, and the filter coefficient updater that calculates a filter coefficient that minimizes the phase difference calculated by the phase-difference calculator.

The torque generator may further include a phase determiner that detects the phase difference between the reference signal and the vibration signal by using the speed signal calculated by the speed calculator and the determined filter coefficient. The tunable filter may be implemented with a filter of a finite impulse response (FIR) type.

The torque generator may further include an anti-phase signal generator that generates a synchronization signal synchronized with the vibration signal extracted by the vibration extractor, based on a phase generated by the reference signal generator, a phase determined by the phase determiner, and a phase detected by a phase-shift amount detector and generates an anti-phase signal to the synchronization signal.

According to another aspect of the present disclosure, an active vibration reduction control method of a hybrid vehicle includes: extracting, by a vibration extraction device, a vibration signal from a motor connected to a drive shaft of the hybrid vehicle; generating, by a torque generator, a first torque for vibration reduction based on the extracted vibration signal; and applying, by a controller, the first torque to the motor.

The method may further include stopping applying the first torque, when a vibration level extracted by the vibration extraction device exceeds a reference value in the state in which the controller applies the first torque to the motor and applying a second torque for vibration reduction to the motor after the application of the first torque is stopped. The torque generator may generate the second torque based on a vibration signal extracted by the vibration extraction device after the application of the first torque is stopped.

The extracting of the vibration signal may include measuring a rotation angle of the motor, calculating a speed signal by performing a differentiation on the measured rotation angle, and extracting the vibration signal by filtering the calculated speed signal.

The extracting of the vibration signal may be performed by using a band-pass digital filter.

### BRIEF DESCRIPTION OF THE DRAWINGS

The above and other objects, features and advantages of the present disclosure will be more apparent from the following detailed description taken in conjunction with the accompanying drawings:

FIG. 1 is a view illustrating a configuration of an active vibration reduction control apparatus of a hybrid vehicle according to an exemplary embodiment of the present disclosure;

FIG. 2 is a detailed view illustrating configurations of a vibration extraction device and a torque generator, which are included in the active vibration reduction control apparatus of the hybrid vehicle, according to an exemplary embodiment of the present disclosure;

FIG. 3 is a performance analysis diagram of the active vibration reduction control apparatus of the hybrid vehicle according to an exemplary embodiment of the present disclosure;

FIG. 4 is a flowchart illustrating an active vibration reduction control method of the hybrid vehicle according to an exemplary embodiment of the present disclosure; and

FIG. 5 is a block diagram illustrating a computing system for executing the active vibration reduction control method of the hybrid vehicle according to an exemplary embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of well-known features or functions will be ruled out in order not to unnecessarily obscure the gist of the present disclosure.

In describing the components of the embodiment according to the present disclosure, terms such as first, second, “A”, “B”, (a), (b), and the like may be used. These terms are merely intended to distinguish one component from another component, and the terms do not limit the nature, sequence or order of the components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

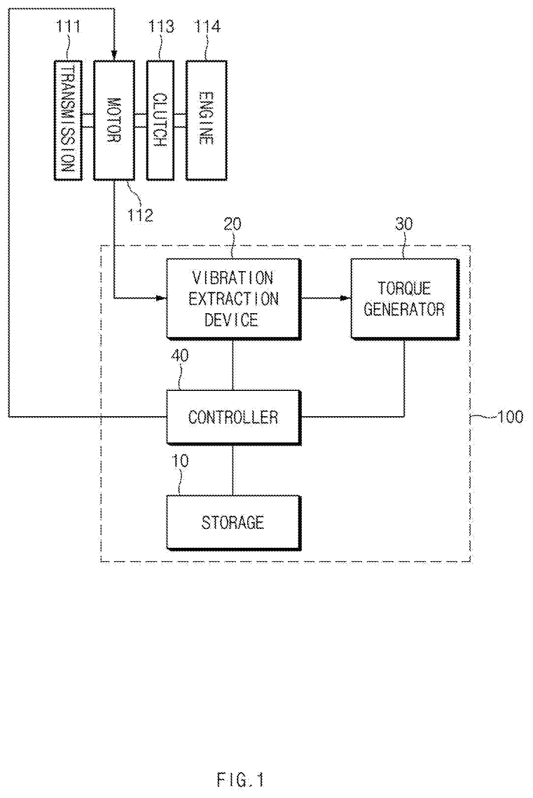

FIG. 1 is a view illustrating a configuration of an active vibration reduction control apparatus of a hybrid vehicle according to an exemplary embodiment of the present disclosure. The hybrid vehicle is a transmission-mounted electric device (TMED) hybrid vehicle in which an engine 114 and a motor 112 are connected through a clutch 113.

As illustrated in FIG. 1, the active vibration reduction control apparatus 100 of the hybrid vehicle according to an exemplary embodiment of the present disclosure may include storage 10, a vibration extraction device 20, a torque generator 30, and a controller 40. The components may be combined together to form one entity, or some of the components may be omitted, depending on a method of carrying out the active vibration reduction control apparatus 100 of the hybrid vehicle according to the embodiment of the present disclosure.

Hereinafter, the aforementioned components will be described in detail. The storage 10 may store various logic, algorithms, and programs that are required in a process of generating a torque for vibration reduction based on a rotation angle of the motor 112 in the hybrid vehicle, applying the torque for vibration reduction to the motor 112 to reduce vibration, and generating and applying a torque for vibration reduction again when the vibration level of the motor 112 exceeds a reference value.

The storage 10 may further store the value (the reference value) that is a basis for determining whether to generate a new torque for vibration reduction, and the reference value may be arbitrarily changed by a user.

The storage 10 may include at least one type of storage medium among memories of a flash memory type, a hard disk type, a micro type, and a card type (e.g., a secure digital (SD) card or an eXtream digital (XD) card) and memories of a random access memory (RAM) type, a static RAM (SRAM) type, a read-only memory (ROM) type, a programmable ROM (PROM) type, an electrically erasable PROM (EEPROM) type, a magnetic RAM (MRAM) type, a magnetic disk type, and an optical disk type.

The vibration extraction device 20 extracts a vibration signal (a vibration component) from the motor 112 connected to a drive shaft of the hybrid vehicle.

The torque generator 30 generates a torque for vibration reduction, based on the vibration signal extracted by the vibration extraction device 20.

The controller 40 performs overall control to enable the components to normally perform functions thereof. The controller 40 may be implemented in a hardware or software form, or may be implemented in a form in which hardware and software are combined together. The controller 40 may be implemented with, but is not limited to, a microprocessor.

The controller 40 may perform various controls that are required in the process of generating the torque for vibration reduction based on the rotation angle of the motor 112 in the hybrid vehicle, applying the torque for vibration reduction to the motor 112 to reduce vibration, and generating and applying the torque for vibration reduction again when the vibration level of the motor 112 exceeds the reference value.

The controller 40 may control the vibration extraction device 20 to extract the vibration signal from the motor 112.

The controller 40 may control the torque generator 30 to generate the torque for vibration reduction, based on the vibration signal extracted by the vibration extraction device 20.

The controller 40 may apply the torque for vibration reduction, which is generated by the torque generator 30, to the motor 112.

When the vibration level extracted by the vibration extraction device 20 exceeds the reference value in the state in which the controller 40 applies the torque for vibration reduction to the motor 112, the controller 40 may stop applying the torque for vibration reduction and may then apply, to the motor 112, a new torque for vibration reduction that is generated by the torque generator 30. At this time, the torque generator 30 generates the new torque for vibration reduction, based on a vibration signal extracted by the vibration extraction device 20 after the application of the torque for vibration reduction to the motor 112 is stopped.

The motor 112 is connected with the engine 114 through a torsional damper (not illustrated) and the engine clutch 113. The motor 112 basically drives the vehicle based on high voltage from a battery. In particular, in the present disclosure, the motor 112 serves as a subject that reduces vibration as well as detecting the vibration. That is, the motor 112 prevents vibration from being transmitted from the engine 114 to a terminal of a transmission 111.

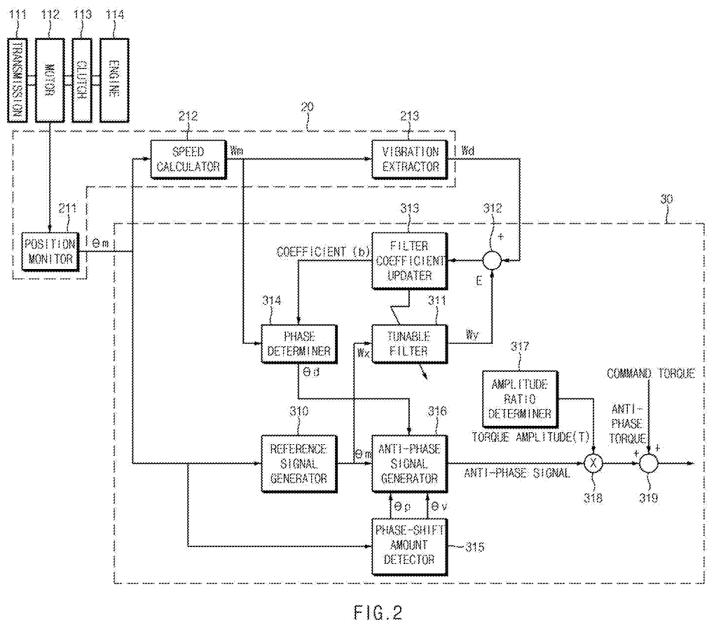

FIG. 2 is a detailed view illustrating configurations of the vibration extraction device and the torque generator, which are included in the active vibration reduction control apparatus of the hybrid vehicle, according to an embodiment of the present disclosure.

As illustrated in FIG. 2, the vibration extraction device 20 may include a position monitor (a resolver) 211 that measures the position (hereinafter, referred to as the rotation angle) of a rotor in the motor 112, a speed calculator 212 that calculates a speed signal by performing a differentiation on the rotation angle Om measured by the position monitor 211, and a vibration extractor 213 that extracts a vibration signal by filtering the speed signal calculated by the speed calculator 212.

The vibration extractor 213 may be implemented with a band-pass digital filter that passes only a vibration component generated by an explosion in the engine 114. The cutoff frequency of the digital filter may be used by determining a desired range in advance, or may be varied and used based on the engine RPM. For example, in the case of a 4-cylinder, 4-stroke internal combustion engine, two explosions occur every time a crankshaft mechanically makes one revolution. Therefore, an explosion component of a frequency that is twice the engine RPM may be observed, and a cutoff frequency may be determined in view of that.

The torque generator 30 may include a reference signal generator 310, a tunable filter 311, a phase-difference calculator 312, a filter coefficient updater 313, a phase determiner 314, a phase-shift amount detector 315, an anti-phase signal generator 316, an amplitude ratio determiner 317, a multiplier 318, and a summer 319.

The reference signal generator 310 generates a reference signal based on the rotation angle (the phase) measured by the position monitor 211. That is, the reference signal generator 310 generates a unit sinusoidal wave with amplitude of 1.

The reference signal generator 310 generates a result (hereinafter, referred to as a double rotation angle) by multiplying the rotation angle of the motor 112 by 2. Although the multiplier is 2 because the engine 114 is exemplified by the 4-cylinder, 4-stroke internal combustion engine in which two explosions occur every time the crankshaft makes one revolution, a different multiplier may be used for a different type of internal combustion engine.

The reference signal generator 310 may generate the double rotation angle and the reference signal based on the rotation angle measured by the position monitor 211.

The tunable filter 311 of a finite impulse response (FIR) type or an infinite impulse response (IIR) type filters the reference signal Wx, which is generated by the reference signal generator 310, by using a filter coefficient updated by the filter coefficient updater 313.

The phase-difference calculator 312 calculates a phase difference between the reference signal generated by the reference signal generator 310 and the vibration signal extracted by the vibration extractor 213.

The filter coefficient updater 313 calculates filter coefficients b₀, b₁, . . . that minimize the phase difference between the reference signal generated by the reference signal generator 310 and the vibration signal extracted by the vibration extractor 213, by using a recursive least square (RLS) algorithm. In the case where the clutch 113 is located between the motor 112 and the engine 114, the filter coefficient updater 313 stops updating the coefficients when power transmission is disengaged and updates the coefficients only when power transmission is engaged.

The phase determiner 314 detects the phase difference between the reference signal generated by the reference signal generator 310 and the vibration signal extracted by the vibration extractor 213, by using the speed signal calculated by the speed calculator 212 and the coefficients determined by the filter coefficient updater 313.

The phase-shift amount detector 315 may detect a compensation value θₚ for compensating for a phase difference due to a transfer delay from the vibration extractor 213 to the motor 112.

The phase-shift amount detector 315 may further detect a compensation value θᵥ for compensating for a phase lag generated by the vibration extractor 213. The phase lag refers to a phase lag generated by the vibration extractor 213, that is, the band-pass filter.

The anti-phase signal generator 316 generates a synchronization signal synchronized with the vibration signal, which is extracted by the vibration extractor 213, based on a phase θₘ generated by the reference signal generator 310, a phase θ_{d} detected by the phase determiner 314, and the compensation value θₚ detected by the phase-shift amount detector 315, and the anti-phase signal generator 316 generates an anti-phase signal to the synchronization signal.

The multiplier 318 generates an anti-phase torque by multiplying the anti-phase signal, which is generated by the anti-phase signal generator 316, by a reference torque. The reference torque may be a preset constant. Alternatively, the reference torque may be a predetermined percentage of an engine torque or a total torque applied to a powertrain. In another case, the reference torque may be a value obtained by multiplying the engine torque or the total torque applied to the powertrain by an amplitude ratio in a frequency domain.

The summer 319 generates a torque for vibration reduction by adding the anti-phase torque generated by the multiplier 318 and a command torque.

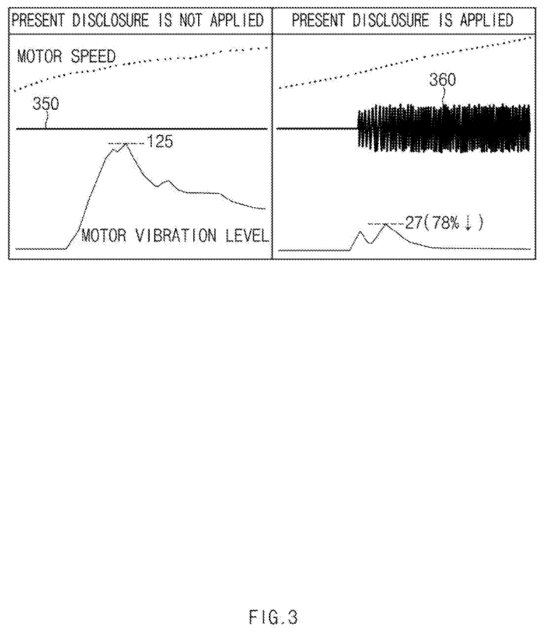

FIG. 3 is a performance analysis diagram of the active vibration reduction control apparatus of the hybrid vehicle according to an embodiment of the present disclosure.

As illustrated in FIG. 3, it can be seen that the drive shaft has a very high vibration level of 125, which is measured through the motor 112, when the present disclosure is not applied, that is, when a torque 350 for vibration reduction is not applied to the motor 112.

In contrast, it can be seen that the vibration level of the drive shaft, which is measured through the motor 112, is reduced to 27 that is about 78% lower than the value of 125, when the present disclosure is applied, that is, when the torque 350 for vibration reduction is applied to the motor 112.

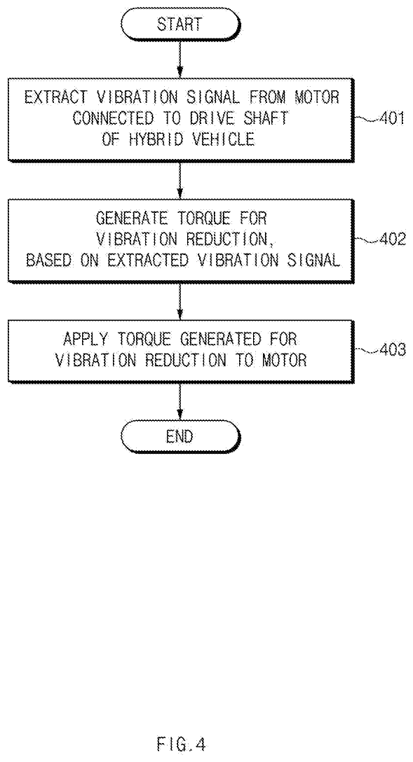

FIG. 4 is a flowchart illustrating an active vibration reduction control method of the hybrid vehicle according to an embodiment of the present disclosure.

First, the vibration extraction device 20 extracts a vibration signal from the motor 112 connected to the drive shaft of the hybrid vehicle (401).

Next, the torque generator 30 generates a torque for vibration reduction, based on the vibration signal extracted by the vibration extraction device 20 (402).

Then, the controller 40 applies the torque for vibration reduction, which is generated by the torque generator 30, to the motor 112 (403).

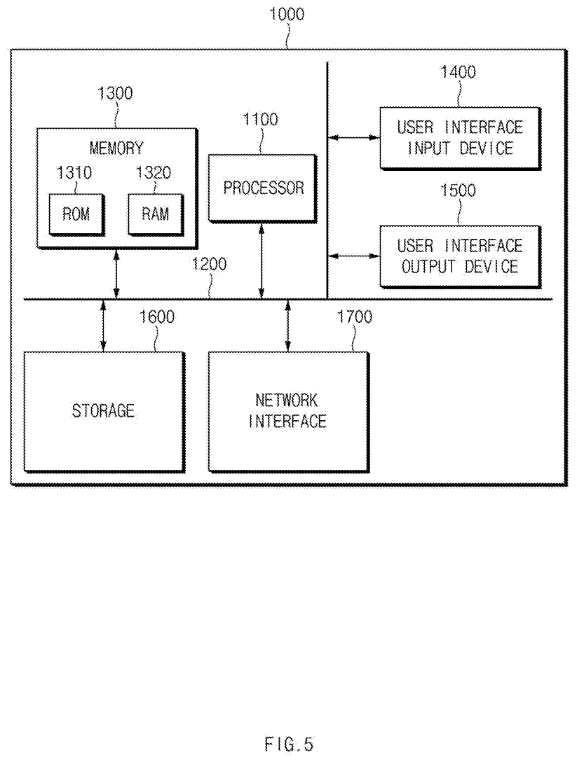

FIG. 5 is a block diagram illustrating a computing system for executing the active vibration reduction control method of the hybrid vehicle according to an embodiment of the present disclosure.

Referring to FIG. 5, the above-described active vibration reduction control method of the hybrid vehicle according to the embodiment of the present disclosure may be implemented through the computing system 1000. The computing system 1000 may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Thus, the operations of the method or the algorithm described in connection with the embodiments disclosed herein may be embodied directly in hardware or a software module executed by the processor 1100, or in a combination thereof. The software module may reside on a storage medium (that is, the memory 1300 and/or the storage 1600) such as a RAM, a flash memory, a ROM, an EPROM, an EEPROM, a register, a hard disk, a removable disk, or a CD-ROM. The exemplary storage medium may be coupled to the processor 1100, and the processor 1100 may read information out of the storage medium and may record information in the storage medium. Alternatively, the storage medium may be integrated with the processor 1100. The processor 1100 and the storage medium may reside in an application specific integrated circuit (ASIC). The ASIC may reside within a user terminal. In another case, the processor 1100 and the storage medium may reside in the user terminal as separate components.

The active vibration reduction control apparatus and method of the hybrid vehicle according to the embodiment of the present disclosure generates the torque for vibration reduction based on the rotation angle of the motor in the hybrid vehicle, applies the torque for vibration reduction to the motor to reduce vibration, and generates and applies the new torque for vibration reduction when the vibration level of the motor exceeds the reference value, thereby preventing the level of vibration generated in the hybrid vehicle from exceeding the reference value.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

What is claimed is:

1. An active vibration reduction control apparatus of a hybrid vehicle comprising:
a vibration extraction device configured to extract a first vibration signal from a motor connected to a drive shaft of the hybrid vehicle;
a torque generator configured to generate a first torque for vibration reduction based on the first vibration signal; and
a controller configured to apply the first torque to the motor.

2. The active vibration reduction control apparatus of claim 1, wherein the controller stops applying the first torque and then applies, to the motor, a second torque for vibration reduction that is generated by the torque generator, when a vibration level extracted by the vibration extraction device exceeds a reference value in a state in which the controller applies the first torque to the motor.

3. The active vibration reduction control apparatus of claim 2, wherein the torque generator generates the second torque based on a second vibration signal extracted by the vibration extraction device after the application of the first torque is stopped.

4. The active vibration reduction control apparatus of claim 1, wherein the vibration extraction device includes:
a position monitor configured to measure a rotation angle of the motor;
a speed calculator configured to calculate a speed signal by performing a differentiation on the rotation angle; and
a vibration extractor configured to extract the first vibration signal by filtering the speed signal.

5. The active vibration reduction control apparatus of claim 4, wherein the vibration extractor is a band-pass digital filter.

6. The active vibration reduction control apparatus of claim 4, wherein the torque generator includes:
a reference signal generator configured to calculate a double rotation angle by multiplying the rotation angle of the motor by 2 and to generate a reference signal using the double rotation angle.

7. The active vibration reduction control apparatus of claim 6, wherein the torque generator further includes:
a tunable filter configured to filter the reference signal by using a filter coefficient updated by a filter coefficient updater;
a phase-difference calculator configured to calculate a phase difference between the reference signal and the first vibration signal; and
the filter coefficient updater configured to calculate a filter coefficient that minimizes the phase difference.

8. The active vibration reduction control apparatus of claim 7, wherein the torque generator further includes:
a phase determiner configured to detect the phase difference between the reference signal and the first vibration signal by using the speed signal and the filter coefficient.

9. The active vibration reduction control apparatus of claim 8, wherein the tunable filter is a filter of a finite impulse response (FIR) type.

10. The active vibration reduction control apparatus of claim 8, wherein the torque generator further includes:
an anti-phase signal generator configured to generate a synchronization signal synchronized with the first vibration signal, based on a phase generated by the reference signal generator, a phase determined by the phase determiner, and a phase detected by a phase-shift amount detector and to generate an anti-phase signal to the synchronization signal.

11. An active vibration reduction control method of a hybrid vehicle comprising:
extracting, by a vibration extraction device, a first vibration signal from a motor connected to a drive shaft of the hybrid vehicle;
generating, by a torque generator, a first torque for vibration reduction based on the first vibration signal; and
applying, by a controller, the first torque to the motor.

12. The active vibration reduction control method of claim 11, further comprising:
stopping the applying the first torque, when a vibration level extracted by the vibration extraction device exceeds a reference value in the state in which the controller applies the first torque to the motor; and
applying a second torque for vibration reduction to the motor after the application of the first torque is stopped.

13. The active vibration reduction control method of claim 12, wherein the applying a second torque for vibration reduction to the motor includes:
generating, by the torque generator, the second torque based on a second vibration signal extracted by the vibration extraction device after the application of the first torque is stopped.

14. The active vibration reduction control method of claim 11, wherein the extracting the first vibration signal from a motor includes:
measuring a rotation angle of the motor;
calculating a speed signal by performing a differentiation on the rotation angle; and
extracting the first vibration signal by filtering the speed signal.

15. The active vibration reduction control method of claim 14, wherein the extracting the first vibration signal from a motor is performed by using a band-pass digital filter.
